(19) United States
(12) Patent Application Publication
(10) Pub. No.: US 2025/0121657 A1
(43) Pub. Date: Apr. 17, 2025

(54) VEHICLE AIR CONDITIONING SYSTEM

(71) Applicant: NGK INSULATORS, LTD., Nagoya-City (JP)

(72) Inventor: Narimasa SHINODA, Ichinomiya-Shi (JP)

(73) Assignee: NGK INSULATORS, LTD., Nagoya-City (JP)

(21) Appl. No.: 18/782,131

(22) Filed: Jul. 24, 2024

(30) Foreign Application Priority Data
Oct. 16, 2023 (JP) 2023-178476

(51) Int. Cl. B60H 3/02; B01D 53/04; B01D 53/26; B01D 53/86; B01J 20/28; B01J 20/34; B01J 35/57

(52) U.S. Cl. CPC B60H 3/024; B01D 53/0438; B01D 53/261; B01D 53/8668; B01D 53/8671; B01J 20/28045; B01J 20/3483; B01J 35/57; B01D 2253/3425; B01D 2257/504; B01D 2257/708; B01D 2257/80; B01D 2258/06; B01D 2259/40098; B01D 2259/402; B01D 2259/4566

(57) ABSTRACT

A vehicle air conditioning system includes: an air conditioning duct for allowing air to flow therethrough; a first humidity control unit having at least one humidity control device including a moisture absorbing material-containing layer, wherein the first humidity control unit is disposed in the air conditioning duct; a second humidity control unit having at least one humidity control member containing a moisture absorbing material, the second humidity control unit being disposed in the air conditioning duct on a downstream side of the first humidity control unit; and a power source for applying a voltage to the humidity control device. The total amount of the moisture absorbing material in the second humidity control unit is 0.3 to 12 times the total amount of the moisture absorbing material in the first humidity control unit.

### CROSS REFERENCE TO RELATED APPLICATIONS

The present invention claims the benefit of priority to Japanese Patent Application No 2023-178476 filed on Oct. 16, 2023 with the Japanese Patent Office, the entire contents of which are incorporated herein by reference in its entirety.

### FIELD OF THE INVENTION

The present invention relates to a vehicle air conditioning system.

### BACKGROUND OF THE INVENTION

In various types of vehicles such as automobiles, there are increasing requirements for improvement of vehicle interior environment. Examples of specific requirements include control of humidity in a vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

To solve the above problem, Patent Literature 1 discloses a vehicle air conditioning system provided with a moisture adsorption device that adsorbs water vapor contained in the air in the vehicle interior and releases the water vapor adsorbed in the moisture adsorption device by heating. The moisture adsorption device includes a moisture adsorption portion for adsorbing water vapor in the air and a plurality of heating portions for individually and directly heating upstream and downstream regions of the moisture adsorption portion during regeneration. The moisture adsorption portion has a predetermined moisture adsorbent supported on a pleated, folded, breathable sheet, and the substrate may be honeycomb shaped or mesh shaped. Each of the heating portions is a plate-shaped heater extending in a direction along an air flow, and is in contact with the sheet in the upstream and downstream regions of the moisture absorbing portion. Such a structure allows the entire moisture absorbing portion to be more uniformly regenerated.

On the other hand, Patent Literature 2 discloses a heater element, including: a pillar shaped honeycomb structure having an outer peripheral wall and partition walls disposed on an inner side of the outer peripheral wall and defining a plurality of cells forming flow paths from a first end face to a second end face, wherein the partition walls have a PTC property, the partition walls have an average thickness of 0.13 mm or less, and the first end face and the second end face have an opening ratio of 0.81 or more. This heater element is used for heating a vehicle interior, and is an efficient heating means because the honeycomb structure allows the heating area to be increased. Therefore, the use of such a heater element as a support for the moisture absorbing material can contribute to the shortening of the regeneration time of the moisture absorbing material. In particular, it is believed that since this heater element can be heated by electric conduction and has a PTC property, it can easily heat the moisture absorbing material, while suppressing excessive heat generation and thermal deterioration of the moisture absorbing material. Further, since the risk of excessive temperature is avoided, safety can be ensured even if small initial resistance is set to increase a heating rate, and the temperature can be increased in a short period of time.

In the vehicle air conditioning system of Patent Literature 1, when performing the regeneration process for releasing the water vapor adsorbed on the moisture absorbent device by heating, air having high humidity flows simultaneously on the downstream side of the moisture absorbent device, so that the water vapor easily agglomerates and forms water droplets on the downstream side of the moisture absorbent device. As a result, the water droplets tend to adhere and remain in the air conditioning duct, making it difficult to discharge them to the vehicle exterior. If the regeneration process is terminated and the moisture absorption process is performed under such conditions, the water droplets may enter the vehicle interior.

The present invention was made to solve the problems as described above. An object of the present invention is to provide a vehicle air conditioning system in which the water droplets are difficult to adhere to the interior of the air conditioning duct.

### PRIOR ART

### Patent Literatures

[Patent Literature 1] Japanese Patent Application Publication No. 2022-80532 A
[Patent Literature 2] WO 2020/036067 A1

### SUMMARY OF THE INVENTION

As a result of intensive studies for vehicle air conditioning systems, the present inventor has found that the above problems can be solved by providing a predetermined first humidity control unit and a predetermined second humidity control unit in the air conditioning duct and controlling a proportion of the total amount of moisture absorbing materials in these humidity control units to an appropriate range, and he has completed the present invention. That is, the present invention is illustrated as follows:

(1)

A vehicle air conditioning system, comprising:
an air conditioning duct for allowing air to flow therethrough;
a first humidity control unit having at least one humidity control device comprising: a honeycomb structure having an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; a pair of electrodes provided on the honeycomb structure; and a moisture absorbing material-containing layer formed on a surface of each of the partition walls, wherein the first humidity control unit is disposed in the air conditioning duct;
a second humidity control unit having at least one humidity control member comprising a moisture absorbing material, the second humidity control unit being disposed in the air conditioning duct on a downstream side of the first humidity control unit; and
a power source for applying a voltage to the humidity control device,
wherein the total amount of the moisture absorbing material in the second humidity control unit is 0.3 to 12 times the total amount of the moisture absorbing material in the first humidity control unit.
   (2)

The vehicle air conditioning system according to (1), wherein the humidity control member comprises: a honeycomb structure having an outer peripheral wall and partition walls disposed on an inner side of the outer peripheral wall, the partition walls defining a plurality of cells, each of the cells extending from a first end face to a second end face to form a flow path; and a moisture absorbing material-containing layer formed on a surface of each of the partition walls.

(3)

The vehicle air conditioning system according to (2), wherein the humidity control member has a thickness of each of the partition walls of 0.06 to 0.40 mm and a cell density of 30 to 95 cells/cm².

(4)

The vehicle air conditioning system according to any one of (1) to (3), wherein the humidity control member does not have a heater function.

(5)

The vehicle air conditioning system according to any one of (1) to (4), wherein the total amount of the moisture absorbing material in the second humidity control unit is 0.5 to 8 times the total amount of the moisture absorbing material in the first humidity control unit.

(6)

The vehicle air conditioning system according to any one of (1) to (5), wherein the total amount of the moisture absorbing material in the second humidity control unit is 0.6 to 6 times the total amount of the moisture absorbing material in the first humidity control unit.

(7)

The vehicle air conditioning system according to any one of (1) to (6), wherein the humidity control device comprises the pair of electrodes on the first end face and the second end face.

(8)

The vehicle air conditioning system according to any one of (1) to (7), wherein a distance between the first humidity control unit and the second humidity control unit is 10 cm or less.

(9)

The vehicle air conditioning system according to any one of (1) to (8),
wherein the air conditioning duct has a first path for allowing the air to flow into a vehicle interior and a second path for discharging the air to a vehicle exterior, on a downstream side of the second humidity control unit, and
wherein the vehicle air conditioning system further comprises a switching valve capable of switching the flow of the air between the first path and the second path.
   (10)

The vehicle air conditioning system according to (9), further comprising a control unit capable of executing:
a dehumidification mode where the vehicle interior is dehumidified by controlling the switching valve to switch the flow of the air to the first path; and
a regeneration mode where the moisture absorbing material is regenerated by applying a voltage from the power source to the pair of electrodes of the humidity control device and controlling the switching valve to switch the flow of the air to the second path.
   (11)

The vehicle air conditioning system according to any one of (1) to (10), wherein the material having the PTC property comprises barium titanate as a main component.

(12)

The vehicle air conditioning system according to any one of (1) to (11), wherein the moisture absorbing material-containing layer of the humidity control device further comprises a functional material having a function of adsorbing at least one selected from carbon dioxide and volatile components, and/or a catalyst.

### BRIEF DESCRIPTION OF THE DRAWINGS

FIG. 1 is a schematic configuration view of the entire vehicle air conditioning system according to an embodiment of the present invention;

FIG. 2A is a schematic view of a cross section of a humidity control device used in a vehicle air conditioning system according to an embodiment of the present invention, which is parallel to a flow path direction;

FIG. 2B is a schematic cross-sectional view of the humidity control device taken along the line a-a′ in FIG. 2A;

FIG. 3 is a graph showing a relationship between a regeneration process time and relative humidity in an air conditioning duct in a presence or absence of a second humidity control unit; and

FIG. 4 is a schematic view of a cross section of a humidity control member used in a vehicle air conditioning system according to an embodiment of the present invention, which is parallel to a flow path direction.

### DETAILED DESCRIPTION OF THE INVENTION

The vehicle air conditioning system according to the present invention includes: an air conditioning duct for allowing air to flow therethrough; a first humidity control unit having at least one humidity control device including: a honeycomb structure having an outer peripheral wall and partition walls disposed on an inner side of the outer peripheral wall, the partition walls defining a plurality of cells, each of the cells extending from a first end face to a second end face to form a flow path, at least the partition walls being made of a material having a PTC (Positive Temperature Coefficient) property; a pair of electrodes provided on the honeycomb structure; and a moisture absorbing material-containing layer formed on a surface of each of the partition walls, wherein the first humidity control unit is disposed in the air conditioning duct; a second humidity control unit having at least one humidity control member containing a moisture absorbing material, the second humidity control unit being disposed in the air conditioning duct on a downstream side of the first humidity control unit; and a power source for applying a voltage to the humidity control device, wherein the total amount of the moisture absorbing material in the second humidity control unit is 0.3 to 12 times the total amount of the moisture absorbing material in the first humidity control unit. This configuration of the vehicle air conditioning system allows some of the moisture in the high humidity air generated by the heating of the first humidity control unit to be temporarily adsorbed in the second humidity control unit on the downstream side during the regeneration process and to be gradually discharged. In other words, since the high humidity air does not flow all at once on the downstream side of the second humidity control unit during the regeneration process, it is possible to prevent water droplets from adhering to and remaining in the air conditioning duct. The vehicle air conditioning system also has good humidity control performance.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

The vehicle air conditioning system according to an embodiment of the present invention can be suitably utilized for various vehicles such as automobiles. The vehicle includes, but not limited to, automobiles and trains. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The vehicle air conditioning system according to the embodiment of the present invention can be particularly suitably used for a vehicle having no internal combustion engine such as electric vehicles and electric railcars.

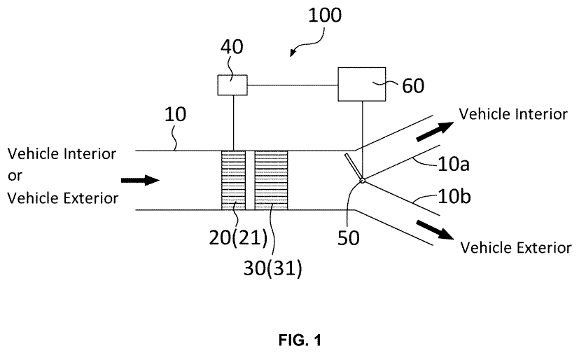

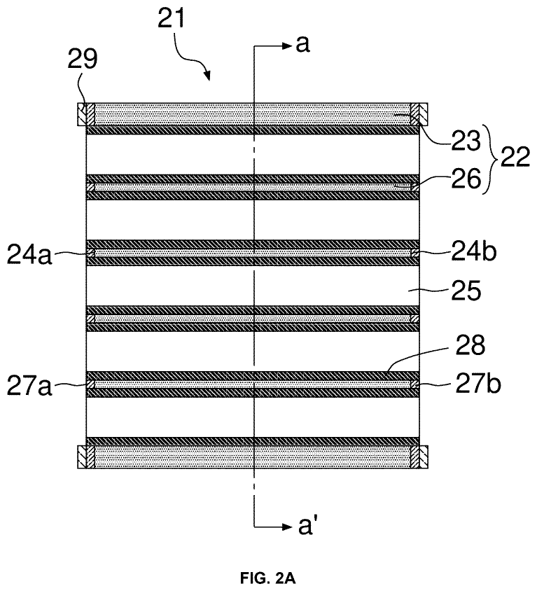

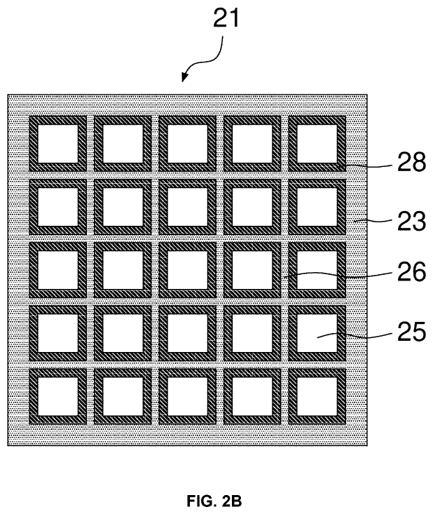

FIG. 1 is a schematic configuration view of the entire vehicle air conditioning system according to an embodiment of the present invention. FIG. 2A is a schematic view of a cross section of a humidity control device used in a vehicle air conditioning system according to an embodiment of the present invention, which is parallel to a flow path direction. FIG. 2B is a schematic cross-sectional view of the humidity control device taken along the line a-a′ in FIG. 2A.

As shown in FIG. 1, a vehicle air conditioning system 100 according to an embodiment of the present invention includes: an air conditioning duct 10; a first humidity control unit 20; a second humidity control unit 30; and a power source 40. The vehicle air conditioning system 100 can further include a switching valve 50 and a control unit 60.

The air conditioning duct 10 allows the air to flow from the vehicle interior or the vehicle exterior therethrough. The air conditioning duct 10 can have a first path 10a for allowing the air to flow into the vehicle interior, and a second path 10b for allowing the air to be discharged to the vehicle exterior, on the downstream side of the second humidity control unit 30.

The first humidity control unit 20 has at least one humidity control device 21 and is disposed in the air conditioning duct 10. It should be noted that FIG. 1 illustrates a case where there is one humidity control device 21.

The second humidity control unit 30 has at least one humidity control member 31 and is disposed in the air conditioning duct 10 on the downstream side of the first humidity control unit 20. It should be note that FIG. 1 illustrates a case where there is one humidity control member 31.

The power source 40 can apply a voltage to the humidity control device 21 of the first humidity control unit 20.

The switching valve 50 can switch the flow of the air between the first path 10a and the second path 10b.

The control unit 60 is connected to the power source 40, the switching valve 50, and the like, and can control these.

As shown in FIGS. 2A and 2B, the humidity control device 21 includes: a honeycomb structure 22 having an outer peripheral wall 23 and partition walls 26 disposed on an inner side of the outer peripheral wall 23, the partition walls 26 defining a plurality of cells 25, each of the cells 25 extending from a first end face 24a to a second end face 24b to form a flow path, at least the partition walls 26 being made of a material having a PTC property; a pair of electrodes 27a, 27b provided on the honeycomb structure 22; and a moisture absorbing material-containing layer 28 formed on a surface of each of the partition walls 26. The humidity control device 21 can further include terminals 29 connected to the pair of electrodes 27a, 27b.

In the vehicle air conditioning system 100 having the above configuration, the air from the vehicle interior or the vehicle exterior flows into the first humidity control unit 20 through the air conditioning duct 10, and moisture in the air is trapped (removed) by the moisture absorbing material-containing layer 28 of the humidity control device 21 in the first humidity control unit 20. Furthermore, the moisture in the air is supplementally trapped (removed) by the humidity control member 31 in the second humidity control unit 30. Then, the air with reduced moisture flows into the vehicle interior through the first path 10a.

On the other hand, the performance of the moisture absorbing material-containing layer 28 of the humidity control device 21 in the first humidity control unit 20 gradually decreases as the amount of trapped moisture increases, so that a regeneration process must be performed for these materials. The regeneration process of the moisture absorbing material-containing layer 28 of the humidity control device 21 is performed by applying a voltage to the pair of electrodes 27a, 27b to heat the honeycomb structure 22. Since the moisture absorbing material-containing layer 28 is directly heated by the heating of the honeycomb structure 22, the moisture trapped in the moisture absorbing material-containing layer 28 is efficiently desorbed or reacted and released from the moisture absorbing material-containing layer 28. A part of the released moisture is trapped by the humidity control member 31 in the second humidity control unit 30 on the downstream side in the initial stage of the regeneration process, so that it can prevent the high humidity air from flowing all at once on the downstream side of the second humidity control unit 30. As a result, it becomes difficult for the moisture to form droplets and adhere to the air conditioning duct 10 on the downstream of the second humidity control unit 30. As the regeneration process of the moisture absorbing material-containing layer 28 progresses, the air heated by the humidity control device 21 also heats the humidity control member 31 in the second humidity control unit 30, and the amount of moisture released from the humidity control member 31 gradually increases. In order to obtain such an effect, the total amount of the moisture absorbing material in the second humidity control unit 30 should be 0.3 to 12 times the total amount of the moisture absorbing material in the first humidity control unit 20. If the total amount of the moisture absorbing material in the second humidity control unit 30 does not satisfy this range, that effect cannot be sufficiently obtained. Furthermore, if the total amount of the moisture absorbing material in the second humidity control unit 30 is too high, the humidity control performance may be deteriorated.

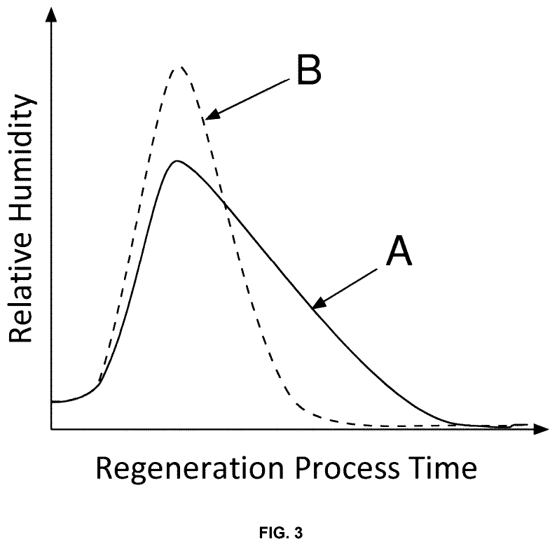

Here, FIG. 3 shows a graph showing a relationship between a regeneration process time and relative humidity in the air conditioning duct 10 in the presence or absence of the second humidity control unit 30. In FIG. 3, the graph A shows a case where the second humidity control unit 30 is provided on the downstream side of the first humidity control unit 20 (it should be noted that the total amount of the moisture absorbing material in the second humidity control unit 30 is 0.3 to 12 times the total amount of the moisture absorbing material in the first humidity control unit 20), and is the relative humidity in the air conditioning duct 10 on the downstream side of the second humidity control unit 30. The graph B shows a case where the second humidity control unit 30 is not provided on the downstream side of the first humidity control unit 20, and is the relative humidity in the air conditioning duct 10 on the downstream side of the first humidity control unit 20.

In the case where the second humidity control unit 30 is not provided (the graph B), the peak of the relative humidity is higher and the peak width is smaller, so that the air having high relative humidity would flow into the air conditioning duct 10 all at once in a short period of time, resulting in easy adhesion of water droplets to the interior of the air conditioning duct 10. On the other hand, when the second humidity control unit 30 is provided (the graph A), the peak of the relative humidity is lower and the peak width is larger than that of the graph B, so that the air with suppressed relative humidity would gradually flow into the air conditioning duct 10, resulting in difficulty for water droplets to adhere to the interior of the air conditioning duct 10.

Hereinafter, each of these components will be described in detail.

### (1. Air Conditioning Duct 10)

The air conditioning duct 10 is a flow path through which the air can flow. The upstream side of the air conditioning duct 10 is connected to the vehicle interior or an outside air introduction port. The air conditioning duct 10 allows the air from the vehicle interior or the vehicle exterior to flow in, and also allows the air that has passed through the first humidity control unit 20 and the second humidity control unit 30 to flow into the vehicle interior or discharge it to the vehicle exterior. Therefore, it is preferable that the air conditioning duct 10 has the first path 10a for allowing the air to flow into the vehicle interior, and the second path 10b for allowing the air to be discharged to the vehicle exterior, on the downstream side of the second humidity control unit 30.

The air conditioning duct 10 may include a switching valve 50 capable of switching the flow of the air between the first path 10a and the second path 10b. The switching valve 50 is not particularly limited as long as it is electrically driven and has the function of switching the flow paths, and a solenoid valve, an electric valve, etc. can be used. For example, the switching valve 50 includes an opening/closing door supported by a rotating shaft and an actuator such as a motor for rotating the rotating shaft. The actuator can be configured to be controllable by the control unit 60.

Also, the air conditioning duct 10 can be provided with a ventilation fan (not shown) for allowing the air from the vehicle interior to flow into the first humidity control unit 20 and the second humidity control unit 30. Although the position of the ventilation fan is not particularly limited, it can be provided, for example, on the upstream side of the first humidity control unit 20.

### (2. First Humidity Control Unit 20)

The first humidity control unit 20 is a unit that includes one or more humidity control devices 21.

The number of the humidity control devices 21 is not particularly limited and may be set as appropriate depending on the required humidity control performance, but it may preferably be 1 to 5, and more preferably 1 to 3.

As shown in FIGS. 2A and 2B, the humidity control device 21 includes: a honeycomb structure 22 having an outer peripheral wall 23 and partition walls 26 disposed on an inner side of the outer peripheral wall 23, the partition walls 26 defining a plurality of cells 25 to form flow paths each extending from the first end face 24a to the second end face 24b; a pair of electrodes 27a, 27b provided on the honeycomb structure 22; and a moisture-absorbing material-containing layer 28 formed on a surface of each of the partition walls 26. The humidity control device 21 can further include terminals 29 connected to the pair of electrodes 27a, 27b.

### (2-1. Honeycomb Structure 22)

The shape of the honeycomb structure 22 is not particularly limited. For example, an outer shape of a cross section of the honeycomb structure 22 orthogonal to the flow path direction of the honeycomb structure 22 (the extending direction of the cells 25) can be polygonal such as quadrangular (rectangular, square), pentagonal, hexagonal, heptagonal, and octagonal, circular, oval (egg-shaped, elliptical, elliptic, rounded rectangular, etc.), or the like. Each of the end faces (first end face 24a and second end face 24b) has the same shape as the cross section. Also, when the cross section and the end faces are polygonal, the corners may be chamfered.

The shape of each cell 25 is not particularly limited, but it may be polygonal such as quadrangular, pentagonal, hexagonal, heptagonal, and octagonal, circular, or oval in the cross section of the honeycomb structure 22 orthogonal to the flow path direction. These shapes may be alone or in combination of two or more. Moreover, among these shapes, the quadrangle or the hexagon is preferable. By providing the cells 25 having such a shape, it is possible to reduce the pressure loss when the air flows.

The honeycomb structure 22 may be a honeycomb joined body having a plurality of honeycomb segments and joining layers that join outer peripheral side surfaces of the plurality of honeycomb segments together. The use of the honeycomb joined body can increase the total cross-sectional area of the cells 25, which is important for ensuring the flow rate of air, while suppressing cracking.

It should be noted that the joining layer can be formed by using a joining material. The joining material is not particularly limited, but a ceramic material obtained by adding a solvent such as water to form a paste can be used. The joining material may contain a material having the PTC property, or may contain the same material as the outer peripheral wall 23 and the partition walls 26. In addition to the role of joining the honeycomb segments to each other, the joining material can also be used as an outer peripheral coating material after joining the honeycomb segments.

From the viewpoints of ensuring the strength of the honeycomb structure 22, reducing pressure loss when air passes through the cells 25, ensuring the amount of functional material supported, and ensuring the contact area with the air flowing inside the cells 25, it is desirable to suitably combine a thickness of the partition wall 26, a cell density, and a cell pitch (or an opening ratio of the cells 25).

As used herein, the cell density refers a value obtained by dividing a number of cells by an area of one end face (first end face 24a or second end face 24b) of the honeycomb structure 22 (the total area of the partition walls 26 and the cells 25 excluding the outer peripheral wall 23).

As used herein, the cell pitch refers to a value obtained by the following calculation. First, the area of one end face (first end face 24a or second end face 24b) of the honeycomb structure 22 (the total area of the partition walls 26 and the cells 25 excluding the outer peripheral wall 23) is divided by the number of the cells to calculate an area per a cell. A square root of the area per a cell is then calculated, and this is determined to be the cell pitch.

As used herein, the opening ratio of the cells 25 refers a value obtained by dividing the total area of the cells 25 defined by the partition walls 26 by the area of one end face 12b (first end face 24a or second end face 24b) (the total area of the partition walls 26 and the cells 25 excluding the outer peripheral wall 23) in the cross section orthogonal to the flow path direction of the honeycomb structure 22. It should be noted that when calculating the opening ratio of the cells 25, the pair of electrodes 27a, 27b, and the moisture absorbing material-containing layer 28 are not taken into account.

In an embodiment that is advantageous from the viewpoint of supporting a sufficient amount of functional material, the thickness of the partition wall 26 is 0.300 mm or less, the cell density is 100 cells/cm² or less, and the cell pitch is 1.0 mm or more. In a preferred embodiment, the thickness of the partition wall 26 is 0.200 mm or less, the cell density is 70 cells/cm² or less, and the cell pitch is 1.2 mm or more. In a more preferred embodiment, the thickness of the partition wall 26 is 0.130 mm or less, the cell density is 65 cells/cm² or less, and the cell pitch is 1.3 mm or more.

From the viewpoints of ensuring the strength of the honeycomb structure 22 and maintaining lower electrical resistance, the lower limit of the thickness of the partition wall 26 is preferably 0.010 mm or more, and more preferably 0.020 mm or more, and even more preferably 0.030 mm or more.

From the viewpoints of ensuring the strength of the honeycomb structure 22, maintaining lower electrical resistance, and increasing a surface area to facilitate reaction, adsorption, and release, the lower limit of the cell density is 30 cells/cm² or more, and preferably 35 cells/cm² or more, and even more preferably 40 cells/cm² or more.

From the viewpoints of ensuring the strength of the honeycomb structure 22, maintaining lower electrical resistance and increasing a surface area to facilitate reaction, adsorption and release, the upper limit of the cell pitch is 2.0 mm or less, and more preferably 1.8 mm or less, and even more preferably 1.6 mm or less.

In an embodiment that is advantageous in terms of both reducing pressure loss and maintaining strength, the thickness of the partition wall 26 is 0.08 to 0.36 mm, the cell density is 2.54 to 140 cells/cm², and the opening ratio of the cells 25 is 0.70 or more. In a preferred embodiment, the thickness of the partition wall 26 is 0.09 to 0.35 mm, the cell density is 15 to 100 cells/cm², and the opening ratio of the cells 25 is 0.80 or more. In a more preferred embodiment, the thickness of the partition wall 26 is 0.14 to 0.30 mm, the cell density is 20 to 90 cells/cm², and the opening ratio of the cells 25 is 0.85 or more.

From the viewpoint of ensuring the strength of the honeycomb structure 22, the upper limit of the opening ratio of the cells 25 is preferably 0.94 or less, and more preferably 0.92 or less, and even more preferably 0.90 or less.

Although the thickness of the outer peripheral wall 23 is not particularly limited, it is preferably determined based on the following viewpoints. First, from the viewpoint of reinforcing the honeycomb structure 22, the thickness of the outer peripheral wall 23 is preferably 0.05 mm or more, and more preferably 0.06 mm or more, and even more preferably 0.08 mm or more. On the other hand, the thickness of the outer peripheral wall 23 is preferably 1.0 mm or less, and more preferably 0.5 mm, and more preferably 0.4 mm or less, and still more preferably 0.3 mm or less, from the viewpoint of suppressing the initial current by increasing the electrical resistance and from the viewpoint of reducing pressure loss when air flows.

As used herein, the thickness of the outer peripheral wall 23 refers to a length from a boundary between the outer peripheral wall 23 and the outermost cell 25 or the partition wall 26 to a side surface of the honeycomb structure 22 in a normal line direction of the side surface in the cross section orthogonal to the flow path direction.

The length in the flow path direction and the cross-sectional area orthogonal to the flow path direction of the honeycomb structure 22 may be adjusted according to the required size of the humidity control device 21, and are not particularly limited. For example, when used in a compact humidity control device 21 while ensuring a predetermined function, the honeycomb structure 22 can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm² or less.

The partition walls 26 forming the honeycomb structure 22 are made of a material that can be heated by electric conduction, specifically made of a material having the PTC property. Further, the outer peripheral wall 23 may also be made of the material having the PTC property, as with the partition walls 26, as needed. By such a configuration, the moisture absorbing material-containing layer 28 can be directly heated by heat transfer from the heat-generating partition walls 26 (and optionally the outer peripheral wall 23). Further, the material having the PTC property has characteristics such that when the temperature increases to exceed the Curie point, the resistance value is sharply increased, resulting in a difficulty for electricity to flow. Therefore, when the temperature of the partition walls 26 (and the outer peripheral wall 23 if necessary) becomes high, the current flowing through them is limited, thereby suppressing excessive heat generation of the honeycomb structure 22. Therefore, it is possible to suppress thermal deterioration of the moisture absorbing material-containing layer 28 due to excessive heat generation.

The lower limit of the volume resistivity at 25° C. of the material having the PTC property is preferably 0.5 Ω·cm or more, and more preferably 1 Ω·cm or more, and even more preferably 5 Ω·cm or more, from the viewpoint of obtaining appropriate heat generation. The upper limit of the volume resistivity at 25° C. of the material having the PTC property is preferably 30 Ω·cm or less, and more preferably 18 Ω·cm or less, and even more preferably 16 Ω·cm or less, from the viewpoint of generating heat with a low driving voltage. As used herein, the volume resistivity at 25° C. of the material having the PTC property is measured according to JIS K 6271:2008.

From the viewpoints that can be heated by electric conduction and has the PTC property, the outer peripheral wall 23 and the partition walls 26 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can also be measured by the same method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

In terms of reduction of the environmental load, it is desirable that the materials used for the outer peripheral wall 23 and the partition walls 26 are substantially free of lead (Pb). More particularly, the outer peripheral wall 23 and the partition walls 26 preferably have a Pb content of 0.01% by mass or less, and more preferably 0.001% by mass or less, and still more preferably 0% by mass. The lower Pb content can allow the air heated by contact with the heat-generating partition walls 26 to be safely applied to organisms such as humans, for example. In the outer peripheral wall 23 and the partition walls 26, the Pb content is preferably less than 0.03% by mass, and more preferably less than 0.01% by mass, and further preferably 0% by mass, as converted to PbO. The lead content can be determined by ICP-MS (inductively coupled plasma mass spectrometry).

The material making up the outer peripheral wall 23 and the partition walls 26 preferably has a Curie point in a temperature range where the resistance value becomes twice or more the resistance at room temperature (25° C.). If the Curie point is in such a temperature range, the current flowing through the humidity control device 21 is limited when the humidity control device 21 reaches a high temperature, so that excessive heat generation of the humidity control device 21 is efficiently suppressed. Therefore, thermal deterioration of the moisture absorbing material-containing layer 28 caused by excessive heat generation can be suppressed.

The material making up the outer peripheral wall 23 and the partition walls 26 preferably have a lower limit of a Curie point of 80° C. or more, and more preferably 100° C. or more, and even more preferably 110° C. or more, and still more preferably 125° C. or more, in terms of efficiently heating the moisture absorbing material-containing layer 28. Further, the upper limit of the Curie point is preferably 200° C. or more, and preferably 190° C. or more, and even more preferably 180° C. or more, and particularly preferably 150° C. or more, in terms of safety as a component placed in the vehicle interior or near the vehicle interior.

The Curie point of the material making up the outer peripheral wall 23 and the partition walls 26 can be adjusted by the type of shifter and an amount of the shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from Hewlett Packard Japan, G.K.). Based on an electrical resistance-temperature plot obtained by the measurement, a temperature at which the resistance value is twice the resistance value at room temperature (25° C.) is defined as the Curie point.

### (2-2. Pair of Electrodes 27a, 27b)

Although the positions of the pair of electrodes 27a, 27b are not particularly limited, but they can be provided on the first end face 24a and the second end face 24b, as shown in FIG. 2A. Further, the pair of electrodes 27a, 27b may be provided on a pair of outer peripheral walls 23 parallel to the extending direction of the cells 25.

Applying of a voltage between the pair of electrodes 27a, 27b allows the honeycomb structure 22 to generate heat by Joule heat.

The pair of electrodes 27a, 27b may employ, for example, a metal or alloy containing at least one selected from Cu, Ag, Al, Ni and Si, although not particularly limited thereto. It is also possible to use an ohmic electrode capable of ohmic contact with the outer peripheral wall 23 and/or the partition walls 26 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 27a, 27b may have a single-layer structure, or may have a laminated structure of two or more layers. When the pair of electrodes 27a, 27b have the laminated structure of two or more layers, the materials of the respective layers may be of the same type or of different types.

The thickness of the pair of electrodes 27a, 27b may be appropriately set according to the method for forming the pair of electrodes 27a, 27b. The method for forming the pair of electrodes 27a, 27b includes metal deposition methods such as sputtering, vapor deposition, electrolytic deposition, and chemical deposition. Alternatively, the pair of electrodes 27a, 27b can be formed by applying an electrode paste and then baking it, or by thermal spraying. Furthermore, the pair of electrodes 27a, 27b may be formed by joining metal sheets or alloy sheets.

Each of the thicknesses of the pair of electrodes 27a, 27b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, its thickness is preferably about 5 to 100 μm.

### (2-3. Terminal 29)

The terminals 29 are connected to the pair of electrodes 27a, 27b and provided on at least a part of the pair of electrodes 27a, 27b. The provision of the terminals 29 facilitates connection to an external power source. The terminals 29 are connected to conducing wires connected to the external power source.

The terminals 29 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 29 are not particularly limited. For example, as shown in FIG. 2A, the terminals 29 can be provided on the whole of the pair of electrodes 27a, 27b on the outer peripheral wall 23. Further, the terminals 29 may be provided on a part of the pair of electrodes 27a, 27b on the outer peripheral wall 23, or may be provided so as to extend toward an outer side than the outer edge of each of the pair of electrodes 27a, 27b on the outer peripheral wall 23. Further, the terminals 29 may be provided on a part of the pair of electrodes 27a, 27b on the partition walls 26, or may be provided so as to block a part of the cells 25.

Furthermore, the thickness of the terminal 29 is not particularly limited, but it is, for example, 0.01 to 10 mm, typically 0.05 to 5 mm.

The method of connecting the terminals 29 to the pair of electrodes 27a, 27b is not particularly limited as long as they are electrically connected. For example, they can be connected by diffusion bonding, a mechanical pressing mechanism, welding, or the like.

### (2-4. Moisture Absorbing Material-Containing Layer 28)

The moisture absorbing material-containing layer 28 is a layer containing a moisture absorbing material and has a function of adsorbing moisture (water vapor).

The moisture absorbing material-containing layer 28 can be provided on the surface of each of the partition walls 26 (in the case of the outermost cells 25, the partition walls 26 that define the outermost cells 25 and the outer peripheral wall 23). By thus providing the moisture absorbing material-containing layer 28, the moisture absorbing material-containing layer 28 can be easily heated during the regeneration process, so that the desired function by the moisture absorbing material-containing layer 28 can be regenerated.

The moisture adsorbing material contained in the moisture absorbing material-containing layer 28 preferably has a function that can adsorb the moisture at −20 to 40° C. and release them at an elevated temperature of 60° C. or more.

Non-limiting examples of the moisture absorbing material include aluminosilicate, silica gel, silica, graphene oxide, polymer adsorbents, polystyrene sulfonic acid, and metal organic frameworks (MOFs: Metal Organic Frameworks). These may be used alone or in combination of two or more.

Examples of the aluminosilicate that can be preferably used herein include AFI type-, CHA type-, or BEA type-zeolite; and porous clay minerals such as allophane and imogolite. Also, it is more preferable that the aluminosilicate is amorphous.

Examples of the silica gel that can be preferably used herein include type A silica gel.

Examples of the polymer adsorbents that can be preferably used herein include those having polyacrylic acid polymer chains. For example, sodium polyacrylate or the like can be used as the polymer adsorbent.

The metal organic framework is a crystalline hybrid material containing metal ions and organic molecules (organic ligands). The metal ions are preferably hydrophilic metal ions (for example, aluminum ions).

The moisture absorbing material-containing layer 28 can contain a functional material that has the function of adsorbing carbon dioxide and/or volatile components. By containing such a functional material, it is possible to obtain an air purifying effect in addition to the air dehumidifying effect.

The functional material preferably has the function of adsorbing carbon dioxide and/or volatile components at −20 to 40° C. and release them at an elevated temperature of 60° C. or higher.

Examples of the functional material having such functions include zeolite, silica gel, activated carbon, alumina, silica, low-crystalline clay, amorphous aluminum silicate complexes, and the like. Types of the functional material may be selected depending on types of components to be removed. The functional material may be used alone, or in combination with two or more types.

In addition, the volatile components contained in the air in the vehicle interior include, for example, volatile organic compounds (VOCs), and odor components other than the VOCs Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl) phenyl N-methylcarbamate, and the like.

The moisture absorbing material-containing layer 28 can contain a catalyst. By containing the catalyst, it is possible to promote oxidation-reduction reaction and the like to purify carbon dioxide and/or volatile components. The catalysts having such functions include metal catalysts such as Pt, Pd and Ag, and oxide catalysts such as CeO₂ and ZrO₂. The catalyst may be used alone, or in combination with two or more types. Further, the catalyst can be used in combination with the functional material as described above.

The thickness of the moisture absorbing material-containing layer 28 may be determined according to the size of the cells 25, and is not particularly limited. For example, the thickness of the moisture absorbing material-containing layer 28 is preferably 20 μm or more, and more preferably 25 μm or more, and even more preferably 30 μm or more, from the viewpoint of ensuring sufficient contact with air. On the other hand, the thickness of the moisture absorbing material-containing layer 28 is preferably 400 μm or less, and more preferably 380 μm or less, and even more preferably 350 μm or less, from the viewpoint of suppressing separation of the moisture absorbing material-containing layer 28 from the partition walls 26 and the outer peripheral wall 23.

The thickness of the moisture absorbing material-containing layer 28 is measured using the following procedure. Any cross section parallel to the flow path direction of the honeycomb structure 22 is cut out, and a cross-sectional image at magnifications of about 50 is acquired using a scanning electron microscope or the like. Also, this cross section is made to pass through the center of gravity position in the cross section orthogonal to the flow path of the honeycomb structure 22. The thickness of each moisture absorbing material-containing layer 28 visually recognized from the cross-sectional image is calculated by dividing the cross-sectional area by the length of the cells 25 in the flow path direction. This calculation is performed for all the moisture absorbing material-containing layers 28 visually recognized from the cross-sectional image, and an average value thereof is determined to be the thickness of the moisture absorbing material-containing layer 28.

From the viewpoint that the functional material and the like exhibit the desired function in the humidity control device 21, an amount of the moisture absorbing material-containing layer 28 is preferably 50 to 500 g/L, and more preferably 100 to 400 g/L, and even more preferably 150 to 350 g/L, based on the volume of the honeycomb structure 22. It should be noted that the volume of the honeycomb structure 22 is a value determined by the external dimensions of the honeycomb structure 22.

### (2-5. Method for Producing Humidity Control Device 21)

The method for producing the humidity control device 21 is not particularly limited, and it can be performed according to a known method. Hereinafter, the method for producing the humidity control device 21 will be illustratively described.

A method for producing the honeycomb structure 22 forming the humidity control device 21 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extrude the green body.

In the extrusion, a die having a desired overall shape, cell shape, partition wall thickness, cell density and the like can be used.

The relative density of the honeycomb formed body obtained by extrusion is 60% or more, and preferably 65% or more. By controlling the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 22 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 22 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 22.

The maintaining time at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining at 900 to 950° C. for 0.5 to 5 hours during the increasing of the temperature. The maintaining at 900 to 950° C. for 0.5 to 5 hours can lead to sufficient decomposition of BaCO₃, so that the honeycomb structure 22 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

On the honeycomb structure 22 thus obtained, the pair of electrodes 27a, 27b are formed. The pair of electrodes 27a, 27b can be formed by metal deposition methods such as sputtering, vapor deposition, electrolytic deposition, and chemical deposition. Further, the pair of electrodes 27a, 27b can also be formed by applying an electrode paste and then baking it. Furthermore, the pair of electrodes 27a, 27b can also be formed by thermal spraying. The pair of electrodes 27a, 27b may be composed of a single layer, but may also be composed of a plurality of electrode layers having different compositions. A typical method for forming the pair of electrodes 27a, 27b will be described below.

First, an electrode slurry containing an electrode material, an organic binder, and a dispersion medium is prepared, and the first end face 24a or the second end face 24b of the honeycomb structure 22 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 22 is removed by blowing and wiping. The slurry can be then dried to form the pair of electrodes 27a, 27b on the first end face 24a or the second end face 24b of the honeycomb structure 22. The drying can be performed while heating the honeycomb structure 22 to a temperature of about 120 to 600° C., for example. Although a series of steps of coating, slurry removal, and drying may be performed only once, the steps can be repeated multiple times to provide the pair of electrodes 27a, 27b having desired thicknesses.

The terminals 29 are then disposed at predetermined positions of the pair of electrodes 27a, 27b, and the pair of electrodes 27a, 27b and the terminals 29 are connected to each other. As a method of connecting the pair of electrodes 27a, 27b to the terminals 29, the method described above can be used.

It should be noted that the terminals 29 may be disposed after forming a moisture absorbing material-containing layer 28 described below.

The moisture absorbing material-containing layer 28 is then formed on the surfaces of the partition walls 26 and the like of the honeycomb structure 22.

Although the method for forming the moisture absorbing material-containing layer 28 is not particularly limited, it can be formed, for example, by the following steps. The honeycomb structure 22 is immersed in a slurry containing a dehumidifying material, an organic binder, and a dispersion medium for a predetermined period of time, and an excess slurry on the end faces and the outer periphery of the honeycomb structure 22 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the moisture absorbing material-containing layer 28 on the surface of each of the partition walls 26. The drying can be performed while heating the honeycomb structure 22 to a temperature of about 120 to 600° C., for example. Although a series of steps of immersion, slurry removal, and drying may be performed only once, the steps can be repeated multiple times to provide the moisture absorbing material-containing layer 28 having the desired thickness on the surface of each of the partition walls 26 and the like.

### (3. Second Humidity Control Unit 30)

The second humidity control unit 30 is a unit that includes one or more humidity control members 31.

The number of the humidity control members 31 is not particularly limited and may be set appropriately depending on the number of humidity control devices 21 in the first humidity control unit 20 disposed on the upstream side, but it may preferably be 1 to 5, and more preferably is 1 to 3.

The humidity control member 31 is provided to prevent the high humidity air generated by the heating of the humidity control device 21 from flowing all at once into the air conditioning duct 10 in the initial stage of the regeneration process, so it may not have a heater function. This is because if the humidity control member 31 is heated to high temperature in the initial stage of the regeneration process, the high humidity air will be generated in the humidity control member 31 as well. However, the humidity control member 31 may have a heater function, provided that the humidity control member 31 is not heated or not heated to the high temperature in the initial stage of the regeneration process.

The humidity control member 31 is not particularly limited, and any known member can be used. Examples of the humidity control member 31 include those in which the moisture absorbing materials are supported on substrates in various shapes such as a sheet shape, a mesh shape, and a honeycomb shape. Further, the humidity control member 31 may be formed by molding moisture absorbing materials into various shapes such as a sheet shape, a mesh shape, a honeycomb shape, or may be formed by filling housings with the moisture absorbing materials having various shapes. Among these, the humidity control member 31 preferably has the honeycomb structure as with the humidity control device 21.

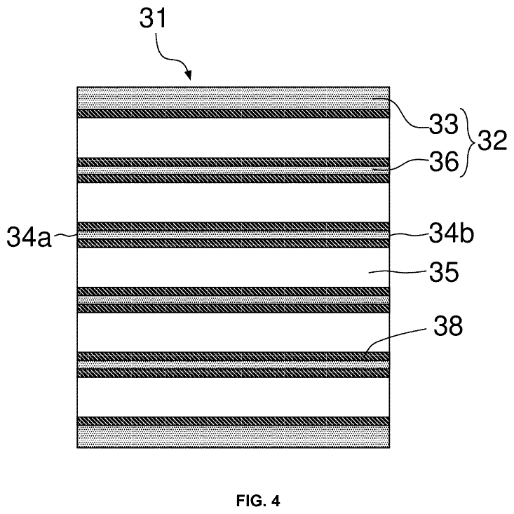

Here, FIG. 4 shows a schematic view of a cross section of the humidity control member 31 having the honeycomb structure parallel to the flow path direction.

As shown in FIG. 4, the humidity control member 31 includes: a honeycomb structure 32 having an outer peripheral wall 33 and partition walls 36 disposed on an inner side of the outer peripheral wall 33, the partition walls 36 defining a plurality of cells 35 each extending from a first end face 34a to a second end face 34b to form a flow path; and a moisture absorbing material-containing layer 38 formed on a surface of each of the partition walls 36. By using the humidity control member 31 having such a structure, it is possible to stably obtain the effect of making it difficult for water droplets to adhere to an interior of the air conditioning duct 10 during the regeneration process, and to improve the moisture absorption performance.

Details such as the shape of the honeycomb structure 32 are not particularly limited, and they can be similar to those of the honeycomb structure 22 used in the humidity control device 21. Therefore, hereinafter, only the features of the honeycomb structure 32 that are different from those of the honeycomb structure 22 used in the humidity control device 21 will be described.

Unlike the honeycomb structure 22, the honeycomb structure 32 does not need to generate heat by electrical conduction. Therefore, the outer peripheral wall 33 and the partition walls 36 that make up the honeycomb structure 32 can be made of SiC, metal bonded SiC, metal composite SiC, Si₃N₄, metal composite Si₃N₄, cordierite, mullite, spinel, alumina, zirconia, zirconia-reinforced alumina or the like. These can be used alone or in combination of two or more.

Here, the “metal bonded SiC” that can be used herein includes metal-impregnated SiC, Si-bonded SiC, SiC bonded with metal Si and other types of metals, and the like. Examples of “other types of metals” include Al (aluminum), Ni (nickel), Cu (copper), Ag (silver), Be (beryllium), Mg (magnesium), Ti (titanium), and the like. Further, the “metal composite SiC” that can be used herein includes those obtained by mixing and sintering SiC particles and metal powder.

In the honeycomb structure 32, it is preferable that the partition walls 36 have a thickness of 0.06 to 0.40 mm and a cell density is 30 to 95 cells/cm², and it is more preferable that the partition walls 36 have a thickness of 0.08 to 0.25 mm and the cell density is 40 to 80 cells/cm². By controlling the thickness of the partition walls 36 and the cell density to such ranges, it is possible to increase moisture absorption performance while maintaining the pressure loss at a low level.

The type of the moisture absorbing material used in the second humidity control unit 30 (humidity control member 31) may be the same as or different from the type of the moisture absorbing material used in the humidity control device 21, but in view of the producibility and production costs, it is preferable that they are the same as each other.

The total amount of the moisture absorbing material in the second humidity control unit 30 is 0.3 to 12 times the total amount of the moisture absorbing material in the first humidity control unit 20. By controlling the total amount of the moisture absorbing material in the second humidity control unit 30 to such a range, the humidity control performance can be improved, and at the initial stage of the regeneration process, the high humidity air can be trapped by the humidity control member 31 in the second humidity control unit 30, and can be prevented from flowing all at once to the downstream side of the second humidity control unit 30. From the viewpoint of stably ensuring this effect, the total amount of the moisture absorbing material in the second humidity control unit 30 is preferably 0.5 to 8 times, preferably 0.6 to 6 times, the total amount of the moisture absorbing material in the first humidity control unit 20.

The method for producing the humidity control member 31 is not particularly limited, and it can be performed according to a known method. For example, when using the humidity control member 31 having the honeycomb structure, it can be performed as in the method for producing the honeycomb structure 22 in the humidity control device 21 as described above.

The second humidity control unit 30 is disposed in the air conditioning duct 10 adjacent to the first humidity control unit 20. The second humidity control unit 30 may or may not be in contact with the first humidity control unit 20. When the first humidity control unit 20 and the second humidity control unit 30 are not in contact with each other, the high humidity air is trapped by the humidity control member 31 in the second humidity control unit 30 in the initial stage of the regeneration process, so that the effect of preventing the high humidity air from flowing all at once to the downstream side of the second humidity control unit 30 can be improved.

When the first humidity control unit 20 and the second humidity control unit 30 are not in contact with each other, it is preferable that the distance between them is 10 cm or less. If the distance is in such a range, it becomes difficult for moisture to remain between the first humidity control unit 20 and the second humidity control unit 30. Moreover, it is preferable that the distance between the first humidity control unit 20 and the second humidity control unit 30 is 1 cm or more.

### (4. Power Source 40)

The power source 40 is for applying a voltage to the pair of electrodes 27a, 27b. The power source 40 is electrically connected to the control unit 60, and adjusts the state of the voltage applied to the pair of electrodes 27a, 27b according to instructions from the control unit 60.

The power source 40 is not particularly limited, and a battery or the like can be used.

### (5. Control Unit 60)

The control unit 60 is connected to the power source 40, the switching valve 50, and the like, and can control these. By controlling the power source 40, the control unit 60 can control the state of voltage application to the pair of electrodes 27a, 27b of the humidity control device 21, and can adjust the heating state of the honeycomb structure 22. Further, the control unit 60 can control the switching valve 50 so that the air flows through the first path 10a or the second path 10b. Furthermore, the control unit 60 can also be electrically connected to a ventilation fan (not shown) to control the ventilation fan.

The control unit 60 is generally an ECU (Engine (electronic) Control Unit), although not particularly limited thereto. The ECU includes a CPU for performing various calculation processes, a ROM for storing programs and data required for its control, a RAM for temporarily storing results of calculations performed by the CPU, and input/output ports for inputting and outputting signals to and from the outside.

The control unit 60 preferably executes a dehumidification mode where the vehicle interior is dehumidified by controlling the switching valve 50 to switch the flow of the air to the first path 10a, and a regeneration mode where the moisture absorbing material is regenerated by applying a voltage from the power source 40 to the pair of electrodes 27a, 27b of the humidity control device 21 and controlling the switching valve 50 to switch the flow of the air to the second path 10b. By executing the dehumidification mode and the regeneration mode in this manner, the dehumidification process and the regeneration process can be efficiently performed.

In the case of the dehumidification mode, the control unit 60 switches the switching valve 50 so that the air flows through the first path 10a, and starts the ventilation fan. Such control allows the air from the vehicle interior or the vehicle exterior to be dehumidified. At this time, the humidity control device 21 of the first humidity control unit 20 is not heated. Specifically, the air from the vehicle interior or the vehicle exterior passes through the air conditioning duct 10 and sequentially flows into the humidity control device 21 of the first humidity control unit 20 and the humidity control member 31 of the second humidity control unit 30, so that the moisture contained in the air is trapped. The dehumidified air is then returned to the vehicle interior through the first path 10a.

In the regeneration mode, the control unit 60 switches the switching valve 50 so that the air flows through the second path 10b, applies the voltage to the pair of electrodes 27a and 27b, and starts the ventilation fan. Such control allows the moisture absorbing material-containing layer 28 of the humidity control device 21 in the first humidity control unit 20 to be regenerated. Specifically, the air from the vehicle interior passes through the air conditioning duct 10 and flows into the humidity control device 21 in the first humidity control unit 20, and while passing through the humidity control device 21, the moisture trapped by the moisture absorbing material-containing layer 28 is released. Also, the air heated by the humidity control device 21 heats the humidity control member 31 in the second humidity control unit 30, and releases the moisture trapped by the humidity control member 31 while passing through the humidity control member 31. The air containing moisture is then discharged to the vehicle exterior through the second path 10b.

In the regeneration mode, it is preferable to heat the moisture absorbing material-containing layer 28 to a temperature higher than a releasing temperature depending on the type of moisture absorbing material in order to promote the release of the moisture trapped by the moisture absorbing material-containing layer 28. For example, the moisture absorbing material-containing layer 28 is preferably heated to 70 to 150° C., more preferably 80 to 140° C., and even more preferably heated to 90 to 130° C.

From the viewpoint of stably performing the above control, it is desirable that the humidity control device 21 of the first humidity control unit 20 be placed at a position close to the vehicle interior. Therefore, from the viewpoint of preventing electric shock and the like, it is preferable that the driving voltage of the humidity control device 21 is 60V or less. Since the honeycomb structure 22 used in the humidity control device 21 has a low electrical resistance at room temperature, the honeycomb structure 22 can be heated at the low driving voltage. It should be noted that the lower limit of the driving voltage is not particularly limited, but it may preferably be 10 V or more. If the driving voltage is less than 10V, the current during heating the honeycomb structure 22 becomes large, so that the conductor wire should be thick.

### EXAMPLES

Hereinafter, the present invention will be described in more detail with reference to Examples, but the present invention is not limited to these Examples.

### <Production of Humidity Control Device>

BaCO₃ powder, TiO₂ powder, and La(NH₃)₃·6H₂O powder were prepared as ceramic raw materials. These powder materials were weighed so as to have a predetermined composition after firing, and were dry-mixed to obtain a mixed powder. The dry mixing was performed for 30 minutes. Suitable amounts of water, a binder, a plasticizer, and a dispersant were then added in a total of 3 to 30 parts by mass per 100 parts by mass of the obtained mixed powder so that a ceramic formed body with a relative density of 64.8% was obtained after extrusion, and they were kneaded to obtain a green body. Methylcellulose was used as the binder. Polyoxyalkylene alkyl ether was used as the plasticizer and the dispersant.

The obtained green body was put into an extrusion molding machine, and extruded using a predetermined die so that it would become a honeycomb structure having the shape as shown below after firing.

Cross section and end face shape of the honeycomb structure orthogonal to the flow path direction: quadrangle;
Shape of the cross section of the cell orthogonal to flow path direction: quadrangle;
Thickness of the partition wall: 0.1 mm;
Thickness of the outer peripheral wall: 0.2 mm;
Cell density: 80 cells/cm²;
Cell pitch: 1.1 mm;
Cross-sectional area orthogonal to the extending direction of the flow path of the honeycomb structure: 6000 mm²;
Length in the extending direction of the flow path of the honeycomb structure: 10 mm;
Volume resistivity at 25° C. of the material making up the outer peripheral wall and the partition walls: 15 Ω·cm; and
Curie point of the material making up the outer peripheral wall and the partition walls: 110° C.

The obtained honeycomb formed body was then dielectrically dried and hot air-dried, and then degreased in an air atmosphere in a firing furnace (450° C.×4 hours), and then fired in an air atmosphere to form a honeycomb structure. For firing, the temperature was held at 950° C. for 1 hour, then raised to 1200° C. and held at 1200° C. for 1 hour, then raised to 1400° C. (maximum temperature) at a rate of 200° C./hour, and then held at 1400° C. for 2 hours.

A pair of electrodes were then formed on both end faces (first end face and second end face) of the obtained honeycomb structure. First, an electrode slurry containing aluminum (electrode material), ethyl cellulose, and diethylene glycol monobutyl ether (organic binder) was prepared and applied to the first end face, and the electrode slurry was then dried to form an electrode on the surface of the first end face. Further, using the same electrode slurry, an electrode was formed on the second end face by applying the electrode slurry to the second end face and drying it.

The honeycomb structure with the pair of electrodes formed thereon was then immersed in a slurry containing zeolite (moisture absorbing material), an organic binder, and water, and the slurry adhering to excess positions (such as the outer periphery) was removed by blowing and wiping, and it was then dried at a temperature of about 550° C. to form a moisture absorbing material-containing layer having the predetermined thickness on a surface of each of the partition walls and a surface of the outer peripheral wall facing the cells. The thickness of the moisture absorbing material-containing layer was controlled by adjusting the number of steps in the series of immersing, slurry removal, and drying.

### <Production of Humidity Control Member>

A cordierite-forming raw material obtained by mixing alumina, kaolin, and talc was used as a ceramic raw material, and a binder containing an organic binder, a water-absorbing resin as a pore former, and water as a dispersion medium were mixed with the cordierite-forming raw material to form a raw material composition, and the raw material composition was kneaded to obtain a green body. The obtained green body was then extruded to obtain a honeycomb formed body having cells. The honeycomb formed body was extruded using a predetermined die so that it became a honeycomb structure having the shape shown below after firing:
Cross section and the end face shape of the honeycomb structure orthogonal to the flow path direction: quadrangle;
Shape of the cross section of the cell orthogonal to flow path direction: quadrangle;
Thickness of the partition wall: 0.1 mm:
Thickness of the outer peripheral wall: 0.2 mm;
Cell density: 70 cells/cm²;
Cross-sectional area orthogonal to the extending direction of the flow path of the honeycomb structure: 6000 mm²; and
Length in the extending direction of the flow path of the honeycomb structure: 10 mm.

The obtained honeycomb formed body was then dielectrically dried and hot air-dried, and then degreased in an air atmosphere in a firing furnace (450° C.×4 hours), and then fired in an air atmosphere (1370° C.×6 hours) to obtain a honeycomb structure.

The resulting honeycomb structure was then immersed in a slurry containing zeolite (moisture absorbing material), an organic binder, and water, and the slurry adhering to excess positions (such as the outer periphery) was removed by blowing and wiping, and it was then dried at a temperature of about 550° C. to form a moisture absorbing material-containing layer having the predetermined thickness on a surface of each of the partition walls and a surface of the outer peripheral wall facing the cells. The thickness of the moisture absorbing material-containing layer was controlled by adjusting the number of steps in the series of immersing, slurry removal, and drying.

### Examples 1 to 12 and Comparative Example 2

A humidity control device (first humidity control unit) and a humidity control member (second humidity control unit) were arranged from the upstream side in a transparent air conditioning duct, and a DC power source device was connected to a pair of electrodes of the humidity control device to produce a vehicle air conditioning system. The ratio of the total amount of the moisture absorbing materials in the humidity control members to the total amount of the moisture absorbing materials in the humidity control devices of each example and each comparative example (which may, hereinafter, be abbreviated as “total amount ratio of moisture absorbing material”), and the distance between the humidity control device and the humidity control member (which may, hereinafter, be abbreviated as “distance between units”) was set as shown in Table 1. Also, a ventilation fan was placed in the air conditioning duct on the upstream side of the humidity control device.

### Comparative Example 1

A vehicle air conditioning system (Conventional Example) was produced by installing only the humidity control device (first humidity control unit) in the transparent air conditioning duct from the upstream side and connecting the DC power source to the pair of electrodes of the humidity control device. Also, a ventilation fan was placed in the air conditioning duct on the upstream side of the humidity control device.

The following evaluations were performed on the vehicle air conditioning systems according to the Examples and Comparative Examples obtained above.

### <Dehumidification Performance>

After performing the regeneration mode on the vehicle air conditioning systems, the dehumidification mode was performed. In the regeneration mode, a voltage of 12V was applied from the DC power source to the humidity control device for 4 minutes while starting the ventilation fan to circulate the air at a temperature of 25° C. and relative humidity of 40% into the air conditioning duct at a flow rate of 20 L/min. The dehumidification mode was performed by flowing the air under the same conditions into the air conditioning duct at a flow rate of 300 L/min without applying the voltage to the humidity control device. In the dehumidification mode, absolute humidity was recorded by humidity sensors placed before and after the humidity control device, and the amount of moisture removed was determined. In this evaluation, the result of Comparative Example 1 was used as a standard, and the improvement rates of the results of each Example and each Comparative Example with respect to the standard were determined. A case where the improvement rate was 8% or more was designated as A, a case where the improvement rate was 5% or more and less than 8% was designated as B, a case where the improvement rate was 2% or more and less than 5% was designated as C, and a case where the improvement rate was less than 2% (which was the same level as Comparative Example 1) was designated as D. It should be noted that if the improvement rate is 2% or more, it can be said that the dehumidification performance is improved as compared to the conventional vehicle air conditioning system.

<Performance of Preventing Water Droplets from Adhering>

In the above dehumidification performance test, whether or not water droplets adhered to the interior of the transparent air conditioning duct was visually evaluated.

In this evaluation, a case there were no water droplets adhering to the interior of the transparent air conditioning duct was designated as A, a case where water droplets adhered to the interior of the air conditioning duct on the downstream side of the humidity control member was designated as Z, and a case where water droplets adhered to the interior of the air conditioning duct between the humidity control device and the humidity control member was designated as Y.

The above evaluation results are shown in Table 1.

TABLE 1

| | Total Amount | | | Performance |
|---|---|---|---|---|
| | Ratio of | | | of |
| | Moisture | | | Preventing |
| | Absorbing | Distance | | Water |
| | Material | Between | Dehumidification | Droplets from |
| | (times) | Units (cm) | Performance | Adhering |
| Ex. 1 | 0.3 | 1 | C | A |
| Ex. 2 | 0.5 | 1 | B | A |
| Ex. 3 | 0.6 | 1 | A | A |
| Ex. 4 | 1 | 1 | A | A |
| Ex. 5 | 1.2 | 1 | A | A |
| Ex. 6 | 3 | 1 | A | A |
| Ex. 7 | 8 | 1 | B | A |
| Ex. 8 | 12 | 1 | C | A |
| Ex. 9 | 1 | 0.2 | A | A |
| Ex. 10 | 1 | 3 | A | A |
| Ex. 11 | 1 | 6 | A | A |
| Ex. 12 | 1 | 10 | A | A |
| Comp. 1 | — | — | — | Z |
| Comp. 2 | 0.2 | 1 | D | Z |

As shown in Table 1, in Examples 1 to 12, the total amount of the moisture absorbing material in the humidity control member (second humidity control unit) is 0.3 to 12 times the total amount of the moisture absorbing material in the humidity control device (first humidity control unit), and both the dehumidification performance and the performance of preventing water droplets from adhering were good.

On the other hand, Comparative Example 1 (Conventional Example) did not have any humidity control member (second humidity control unit), and therefore did not have sufficient performance of preventing water droplets from adhering.

In Comparative Example 2, the total amount of the moisture absorbing material in the humidity control member (second humidity control unit) was less than 0.3 times the total amount of the moisture absorbing material in the humidity control device (first humidity control unit), and therefore both the dehumidification performance and the performance of preventing the water droplets from adhering were not sufficient.

As can be seen from the above results, according to the present invention, it is possible to provide a vehicle air conditioning system in which the water droplets are difficult to adhere to the interior of the air conditioning duct.

### DESCRIPTION OF REFERENCE NUMERALS

10 air conditioning duct
10a first path
10b second path
20 first humidity control unit
21 humidity control device
22 honeycomb structure
23 outer peripheral wall
24a first end face
24b second end face
25 cell
26 partition wall
27a, 27b pair of electrodes
28 moisture absorbing material-containing layer
29 terminal
30 second humidity control unit
31 humidity control member
32 honeycomb structure
33 outer peripheral wall
34a first end face
34b second end face
35 cell
36 partition wall
38 moisture absorbing material-containing layer
40 power source
50 switching valve
60 control unit

1. A vehicle air conditioning system, comprising:
an air conditioning duct for allowing air to flow therethrough;
a first humidity control unit having at least one humidity control device comprising: a honeycomb structure having an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; a pair of electrodes provided on the honeycomb structure; and a moisture absorbing material-containing layer formed on a surface of each of the partition walls, wherein the first humidity control unit is disposed in the air conditioning duct;
a second humidity control unit having at least one humidity control member comprising a moisture absorbing material, the second humidity control unit being disposed in the air conditioning duct on a downstream side of the first humidity control unit; and
a power source for applying a voltage to the humidity control device,
wherein the total amount of the moisture absorbing material in the second humidity control unit is 0.3 to 12 times the total amount of the moisture absorbing material in the first humidity control unit.

2. The vehicle air conditioning system according to claim 1, wherein the humidity control member comprises: a honeycomb structure having an outer peripheral wall and partition walls disposed on an inner side of the outer peripheral wall, the partition walls defining a plurality of cells, each of the cells extending from a first end face to a second end face to form a flow path; and a moisture absorbing material-containing layer formed on a surface of each of the partition walls.

3. The vehicle air conditioning system according to claim 2, wherein the humidity control member has a thickness of each of the partition walls of 0.06 to 0.40 mm and a cell density of 30 to 95 cells/cm².

4. The vehicle air conditioning system according to claim 1, wherein the humidity control member does not have a heater function.

5. The vehicle air conditioning system according to claim 1, wherein the total amount of the moisture absorbing material in the second humidity control unit is 0.5 to 8 times the total amount of the moisture absorbing material in the first humidity control unit.

6. The vehicle air conditioning system according to claim 1, wherein the total amount of the moisture absorbing material in the second humidity control unit is 0.6 to 6 times the total amount of the moisture absorbing material in the first humidity control unit.

7. The vehicle air conditioning system according to claim 1, wherein the humidity control device comprises the pair of electrodes on the first end face and the second end face.

8. The vehicle air conditioning system according to claim 1, wherein a distance between the first humidity control unit and the second humidity control unit is 10 cm or less.

9. The vehicle air conditioning system according to claim 1,
wherein the air conditioning duct has a first path for allowing the air to flow into a vehicle interior and a second path for discharging the air to a vehicle exterior, on a downstream side of the second humidity control unit, and
wherein the vehicle air conditioning system further comprises a switching valve capable of switching the flow of the air between the first path and the second path.

10. The vehicle air conditioning system according to claim 9, further comprising a control unit capable of executing:
a dehumidification mode where the vehicle interior is dehumidified by controlling the switching valve to switch the flow of the air to the first path; and
a regeneration mode where the moisture absorbing material is regenerated by applying a voltage from the power source to the pair of electrodes of the humidity control device and controlling the switching valve to switch the flow of the air to the second path.

11. The vehicle air conditioning system according to claim 1, wherein the material having the PTC property comprises barium titanate as a main component.

12. The vehicle air conditioning system according to claim 1, wherein the moisture absorbing material-containing layer of the humidity control device further comprises a functional material having a function of adsorbing at least one selected from carbon dioxide and volatile components, and/or a catalyst.
